(19) United States
(12) Patent Application Publication
(10) Pub. No.: US 2010/0114370 A1
(43) Pub. Date: May 6, 2010

(54) CONVEYANCE APPARATUS

(75) Inventor: Tsutomu Sasaki, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/641,489

(22) Filed: Dec. 18, 2009

Related U.S. Application Data
(63) Continuation of application No. PCT/JP2007/063125, filed on Jun. 29, 2007.

(51) Int. Cl. G05B 19/418; G05B 19/04

(52) U.S. Cl. 700/248; 700/249; 700/255

(57) ABSTRACT

A conveyance apparatus includes conveyance robots provided for sequential assembly processes. Each of the robots conveys, based on a tact system, work pieces for the respective assembly processes, by simultaneously reciprocating the work pieces with a single mechanism. The work pieces are sequentially assembled on an assembly line after placed at the most upstream side thereof. The apparatus further includes control units respectively provided for the conveyance robots and control time sequences for reciprocating motions of the respective conveyance robots in a linked manner. The control unit for controlling a first conveyance robot receives, from the control unit for controlling a second conveyance robot, position information of the second conveyance robot positioned frontward in a moving direction of the first conveyance robot, thereby detecting presence of a risk of a collision with the second conveyance robot, and causing the first conveyance robot to avoid the collision when the risk exists.

### CROSS-REFERENCE TO RELATED APPLICATION

This is a continuation application of PCT/JP2007/063125, filed on Jun. 29, 2007.

### FIELD

The embodiment discussed herein is related to a conveyance apparatus that conveys a work piece in an assembly line from the upstream side to the downstream side based on a tact system.

### BACKGROUND

There is known a conveyance apparatus that conveys a work piece placed at the most upstream point and sequentially assembled in an assembly line, from the upstream side to the downstream side based on a tact system for each assembly process. As one of this type of conveyance apparatus, there is an apparatus having such a structure that any number of conveyance robots may be linked according to the number of processes in an assembly line. In this kind of conveyance apparatus, one conveyance robot is provided for each of sequential assembly processes, and the conveyance robots simultaneously reciprocate so that work pieces present at the respective sequential assembly processes are conveyed at the same time in a single mechanism based on a tact system. Incidentally, an assembly line includes many assembly processes. Therefore, in the following description, the words “upstream side” and “downstream side” may be referred to as “upstream process” and “downstream process,” respectively, to clearly indicate the order.

FIG. 1, FIG. 2 and FIG. 3 are diagrams that illustrate a conventional conveyance apparatus 1.

FIG. 1 and FIG. 2 illustrate the conveyance apparatus 1 that includes three conveyance robots 10 each of which is provided for three sequential assembly processes. In particular, the conveyance apparatus 1 having an assembly line that includes nine assembly processes for producing a hard disk drive (hereinafter referred to as HDD) is illustrated in FIG. 1 and FIG. 2. FIG. 2 also illustrates how control units incorporated in the respective conveyance robots 10 of the conveyance apparatus 1 illustrated in FIG. 1 operate in an interlock manner. FIG. 3 illustrates an internal structure of the conveyance robot 10 illustrated in FIG. 1.

As illustrated in FIG. 1, each of the conveyance robots 10 is provided to handle three sequential assembly processes and includes a mechanism 10A. The mechanisms 10A of the respective conveyance robots 10 convey work pieces W1 through W9 by simultaneously reciprocating based on a tact system. When the mechanisms 10A reciprocate, the work pieces W1 through W9 are sequentially conveyed from the upstream side to the downstream side. Illustrated on the left side in FIG. 1 is the most upstream point of the assembly line. For example, when a housing case of a HDD is placed at the most upstream point, a component is incorporated into the housing case in each of assembly processes that are downstream processes when viewed from the process at the most upstream point. The work piece into which the components have been incorporated at the respective assembly processes is sequentially moved to the downstream assembly processes (post-processes), and the HDD is finally assembled. Incidentally, the conveyance apparatus in FIG. 1 has such a structure that when the number of assembly processes is more than nine, another conveyance robot 10 may be added.

Here, a time sequence from time t1 to time t6 will be described by referring to FIG. 1.

In order to describe the time sequence of each of the conveyance robots 10 provided in the conveyance apparatus 1, each of parts (a) to (f) of FIG. 1 illustrates: the positions of the respective mechanisms 10A provided in the respective conveyance robots 10; and the positions of the respective work pieces W1 to W9 at each of the times t1 to t6. Incidentally, each of parts (a) to (f) in FIG. 1 also illustrates arrows each of which indicates a direction in which the mechanism 10A moves until the next time arrives.

First, at the time t1 corresponding to the initial state, the mechanisms 10A of the respective conveyance robots 10 are located at the respective positions illustrated in part (a) of FIG. 1. When a command comes from a controller 110, which will be described later, in the state where the mechanisms 10A are located at these positions, the action of each of the conveyance robots 10 begins under the control of each PLC 100 which will be described later.

Firstly, when a command comes from the controller 100 at the time t1, the mechanisms 10A are moved in the directions indicated with the arrows illustrated in part (a) of FIG. 1. Subsequently, as illustrated in part (b) of FIG. 1, the mechanisms 10A are located at the respective positions in part (b) of FIG. 1 at the time t2. Next, at the time 3, the mechanisms 10A are moved upward as illustrated in part (c) of FIG. 1 to lift the work pieces W1 to W9 on mounting stages 10B. Further, at the subsequent time t4, the mechanisms 10A are moved to the respective positions illustrated in part (d) of

FIG. 1 while keeping the work pieces W1 to W9 lifted. After the mechanisms 10A are moved to the respective positions illustrated in part (d) of FIG. 1, i.e. every one of the work pieces W1 to W9 is moved to the subsequent downstream process, the mechanisms 10A are moved downward to place the work pieces W1 to W9 respectively on the mounting stages 10B of the subsequent downstream processes as illustrated in part (e) of FIG. 1 at the subsequent time t5. Next, as illustrated in part (f) of FIG. 1, each of the mechanisms 10A comes back to the initial position illustrated in part (a) of FIG. 1 and thereafter, a series of conveying motions from part (a) to part (f) of FIG. 1 are repeated until all the work pieces W1 to W9 reach the final process after conveyed.

Here, with reference to FIG. 2, there will be described how control units of the conveyance apparatus 1 operate in an interlock manner.

As illustrated in FIG. 2, PLCs (Programmable Logic Controllers) 100 are incorporated into the conveyance apparatus 1 illustrated in FIG. 1, as the control units. These PLCs 100 are linked by a network NW. Also, a controller 110 for providing commands to each of the PLCs 100 is connected to the network NW. Further, a touch panel 111 for operation is connected to the controller 110. When a start button 1111 provided in the touch panel 111 is operated, the operation of the start button 1111 is transmitted to each of the PLCs 100. Subsequently, under the control of the PLCs 100, reciprocating motions of the mechanisms 10A of the respective conveyance robots 10 are repeated, so that the work pieces W1 to W9 of the respective assembly processes are conveyed based on a tact system. Incidentally, a sequencer illustrated in FIG. 2 is used as the PLC 100. In FIG. 2, a word “CONNECTABLE” represents a fact that when another conveyance robot 10 is additionally connected, another PLC 100 for controlling this additional conveyance robot 10 may be connected to the network NW.

Further, provided inside the conveyance robot 10 illustrated in FIG. 3 are: a conveyance motor M1 for causing the mechanism 10A of the conveyance robot 10 to reciprocate; and a lifting-lowering motor M2 for causing the mechanism 10A to lift and lower the work pieces W1 to W9. Furthermore, although not illustrated in FIG. 3, there is provided a ball screw (not illustrated) extended along a horizontal direction; so that the mechanism 10A linked to the conveyance motor M1 is able to reciprocate. There is also provided a ball screw linked to the lifting-lowering motor M2 and extended along a vertical direction in FIG. 1, so that the mechanism 10A is lifted and lowered.

A driver unit DR is connected to these motors M1 and M2. When a drive command is provided by the PLC 100 to the driver unit DR, the motors M1 and M2 are supplied with driving signals corresponding to the drive command provided by the PLC 100, so that the motors M1 and M2 are rotated, which enables the mechanism 10A linked to the ball screws (not shown) to move vertically and reciprocate.

Also, when causing the conveyance robots 10 to move vertically and reciprocate by giving a command to the driver units DR, the PLCs 100 are unable to allow the respective conveyance robots 10 to carry out interlocking movement unless the positions for lifting and lowering and the positions for reciprocating of the mechanisms 10A of the respective conveyance robots 10 are known. Therefore, each of the PLCs 100 receives position information from encoders ENC1 and ENC2 of the motors M1 and M2, respectively, thereby causing the motors M1 and M2 to stop or operate.

Note that in the conveyance apparatus described above, typically, when, for example, an operator has dropped a work piece from the mounting stage in any of the assembly processes, the operator pushes a temporary-stop button 100S provided at the conveyance robot 10 (single temporary-stop button 100S for single conveyance robot 10), thereby halting the conveyance robots 10 for all the remaining assembly processes. Subsequently, after carrying out a recovery work such as putting the dropped work piece back on the mounting stage, the operator allows all the conveyance robots 10 to resume the reciprocating movement. However, it is quite inefficient to stop the conveyance robots 10 of all the assembly processes at a time just because a trouble has occurred in any of the assembly processes.

Considering this inefficiency, it is conceivable to stop any of the conveyance robots by pushing the temporary-stop button 100S and let the remaining conveyance robots keep operating.

However, there is a possibility that a collision might occur between the stopped conveyance robot and the conveyance robot in the upstream process and between the stopped conveyance robot and the conveyance robot in the downstream process. It is easy to avoid the collision by using, for example, a technique described in Japanese Patent Laid-open Publication No. H06-155186 or Japanese Patent Laid-open Publication No. H07-261841. However, the techniques described in these documents are not related to a conveyance robot and are unable to let, when at least one of conveyance robots is stopped, the remaining conveyance robots keep operating while avoiding collision.

### SUMMARY

According to an aspect of the invention, a conveyance apparatus includes:

a plurality of conveyance robots each of which is provided at each of a plurality of sequential assembly processes and conveys, based on a tact system, a plurality of work pieces by simultaneously reciprocating the plurality of work pieces by using a single mechanism, the plurality of work pieces respectively existing for the plurality of sequential assembly processes and sequentially assembled on an assembly line after placed at a most upstream side of the assembly line; and

a plurality of control units respectively provided for the plurality of conveyance robots and control time sequences for reciprocating motions of the respective conveyance robots,

wherein the plurality of control units control the time sequences for the reciprocating motions of the respective conveyance robots in a linked manner, and

each of the plurality of control units controls the time sequence of a first conveyance robot among the conveyance robots and receives, from another control unit controlling the time sequence of a second conveyance robot among the conveyance robots, position information of the second conveyance robot positioned frontward in a moving direction of the first conveyance robot, thereby detecting presence of a risk of a collision with the second conveyance robot, and causing the first conveyance robot to act to avoid the collision when the risk of the collision is present.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram that illustrates a conventional conveyance apparatus;

FIG. 2 is a diagram that illustrates an internal structure of the conveyance apparatus illustrated in FIG. 1;

FIG. 3 is a diagram that illustrates an internal structure of a conveyance robot of the conveyance apparatus illustrated in FIG. 1;

FIG. 4 is a diagram that illustrates a conveyance apparatus according to an embodiment of the present invention;

FIG. 5 is a diagram that illustrates a flow of a program describing a procedure carried out by a PLC 100P;

FIG. 6 is a diagram that illustrates actions taking place when the program in FIG. 5 is run by a sequencer which is the PCL 100P;

FIG. 7 is a diagram that illustrates the actions taking place when the program in FIG. 5 is run by the sequencer which is the PCL 100P; and

FIG. 8 is a diagram that illustrates a structure in which a recovery button 100PR is added to the structure in FIG. 4.

### DESCRIPTION OF EMBODIMENT

An embodiment of the present invention will be described below.

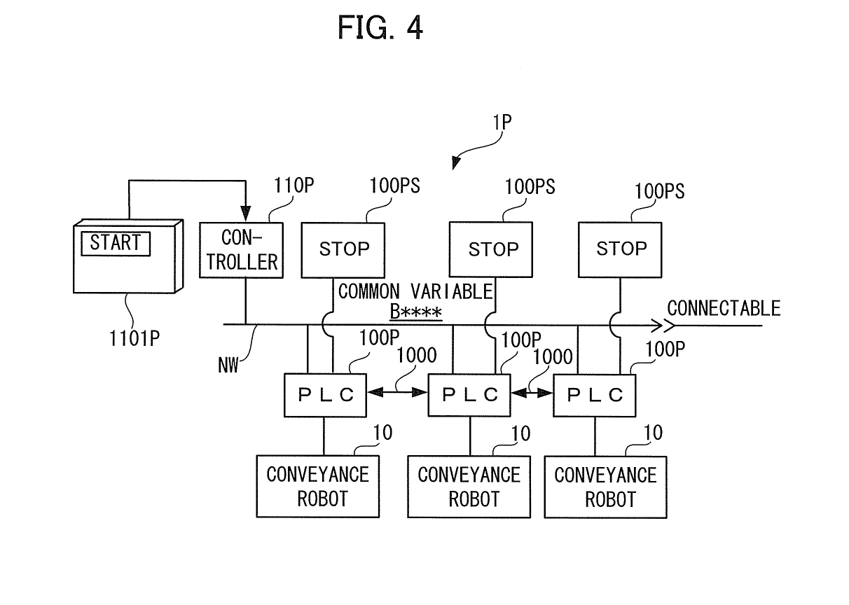

FIG. 4 is a diagram that illustrates a conveyance apparatus 1P according to an embodiment of the present invention.

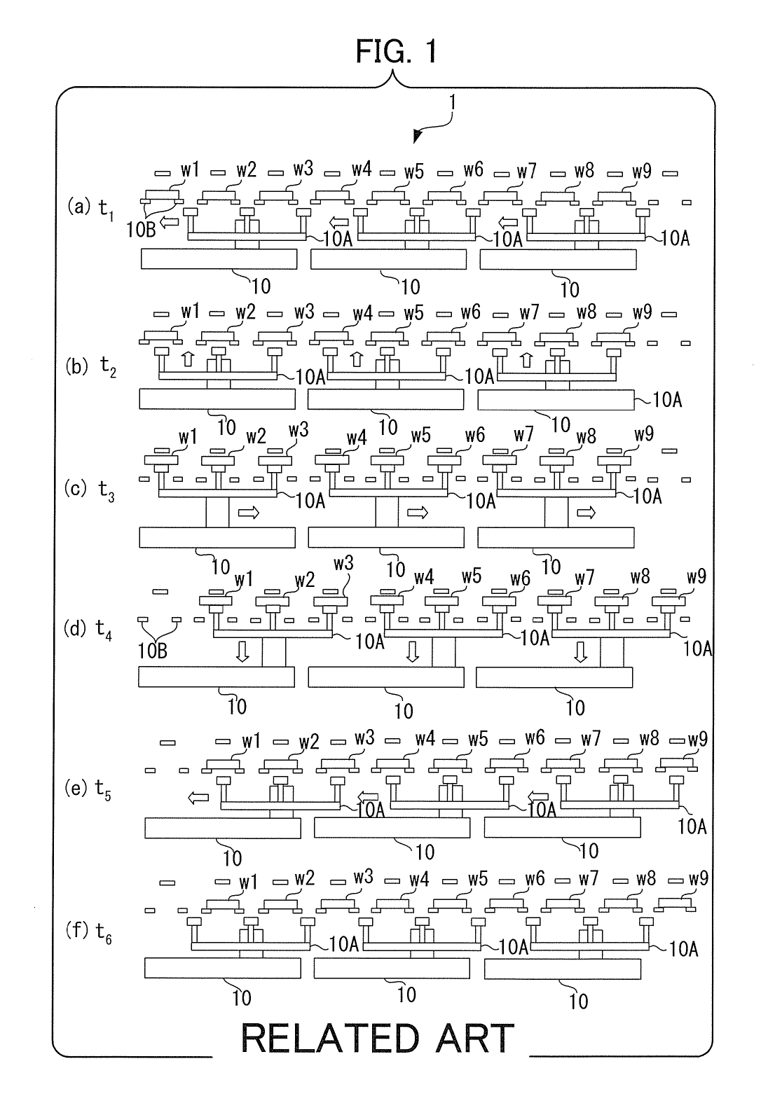

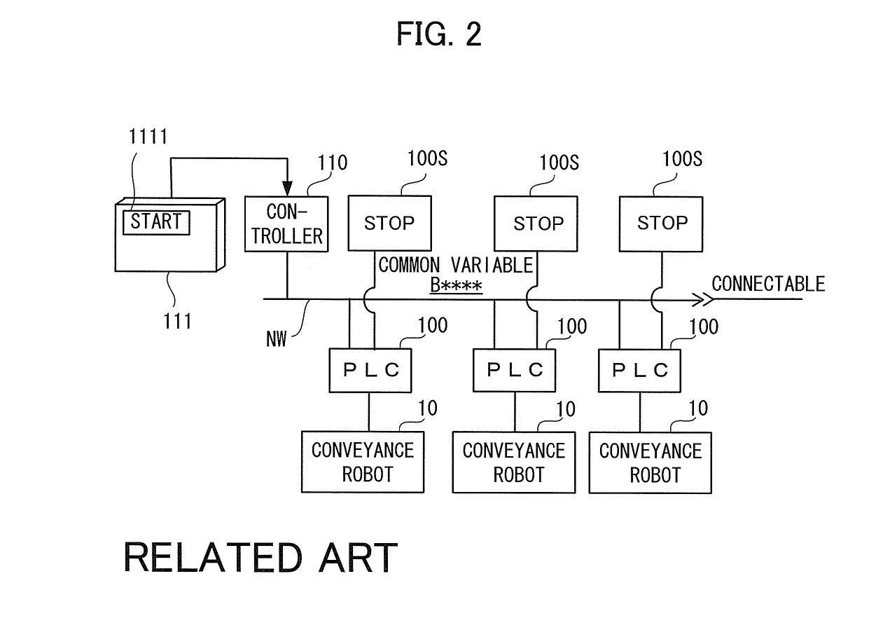

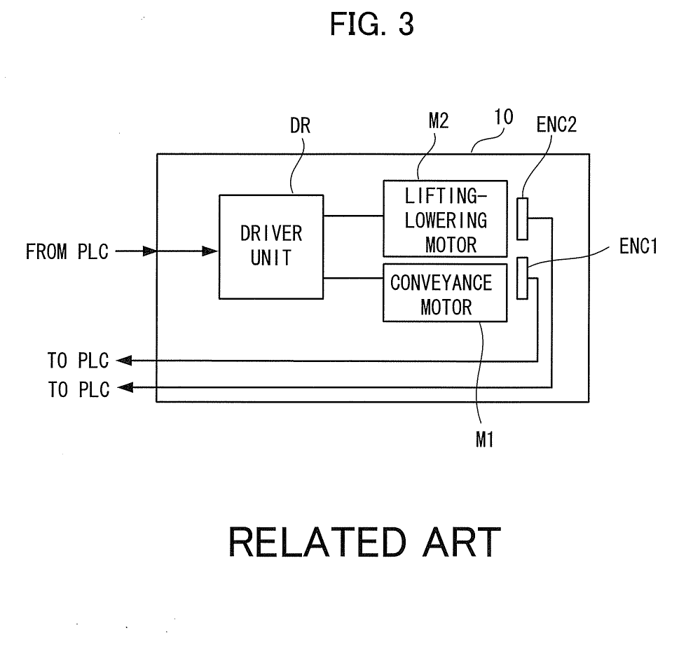

The structure of the conveyance apparatus 1P in FIG. 4 is similar to that of the conveyance apparatus 1 in FIG. 1, FIG. 2 and FIG. 3, except that communication lines 1000 are added and a program running inside each PLC 100P is different from that of the PLC 100.

Each of the three PLCs 100P illustrated in FIG. 4 is a sequencer. These three sequencers are interconnected like those in FIG. 2 by a network NW, and control a sequence of reciprocating motions of three conveyance robots 10 in conjunction with one another through communications via the network NW. Also, in the present embodiment, each of the three PLCs 100P is connected, with communication lines 1000, to two PLCs 100P for controlling the two conveyance robots 10 next to and located on both sides of its own conveyance robot 10. To these two PLCs 100P, the PLC 100P transmits the position information of the conveyance robot 10 controlled by this PLC 100P. Further, each of the three PLCs 100P operates such that the PLC 100P for controlling the first conveyance robot 10 receives the position information of the second conveyance robot 10 positioned forward in the moving direction of the first conveyance robot 10, from the PLC 100P for controlling the second conveyance robot 10.

In other words, in the structure illustrated in FIG. 4, the adjacent PLCs 100P are connected to each other with the communication line 1000, and encoder signals from encoders ENC1 and ENC2 (similar to those in FIG. 3) are also transmitted to the PLC 100P for controlling the conveyance robot 10 in the upstream process via the communication line 1000. Incidentally, each of the PLCs 100P may include a parallel data communication device or a serial data communication device. In either case, these communication devices are connected to each other via the communication line 1000.

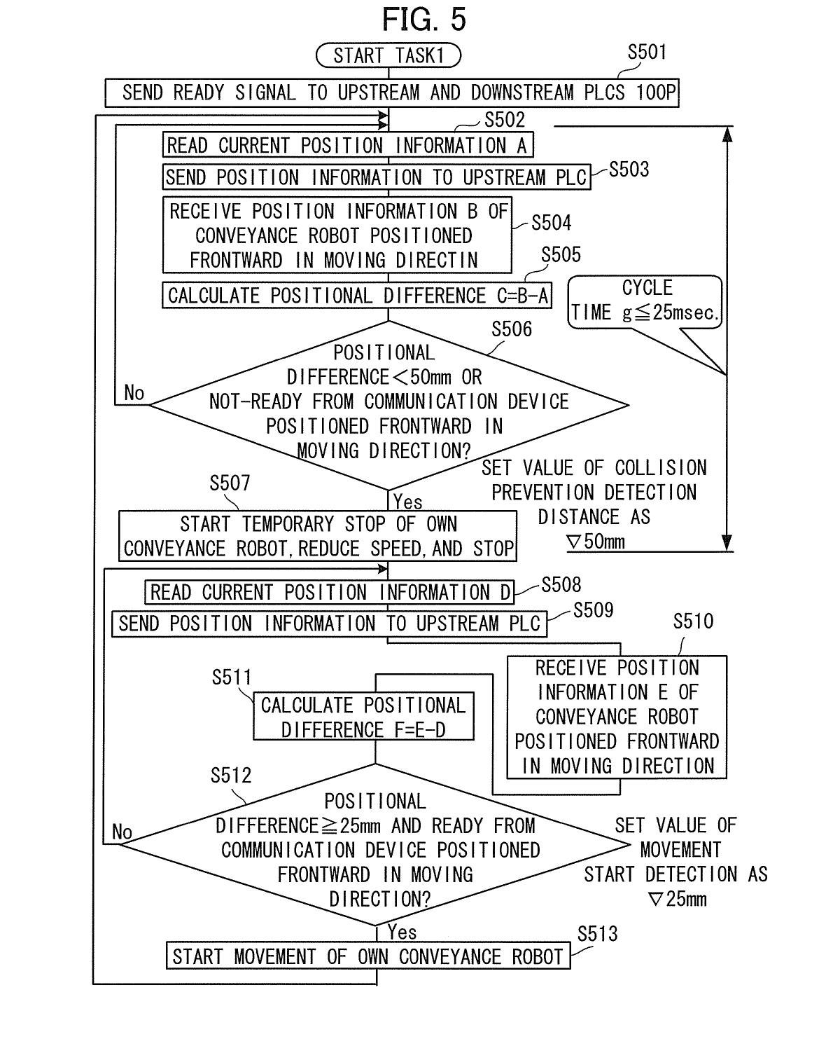

FIG. 5 is a diagram that illustrates a flow of a program describing a procedure carried out by the PLC 100P. The processes in the flow illustrated in FIG. 5 are repeatedly carried out by the sequencer 100P which is the PLC. Now, the flow illustrated in FIG. 5 will be described.

In step S501, each of the PLCs 100P transmits a ready signal indicating that an internal communication device is operable to the PLC 100P in the upstream process and the PLC 100P in the downstream process.

Subsequently, in step S502, each of the PLCs 100P reads a current position A based on an encoder signal from the encoder ENC in the conveyance robot 10 controlled by this PLC 100P. Next, in step S503, current position information is transmitted to the PLC 100P controlling the conveyance robot 10 in the upstream process.

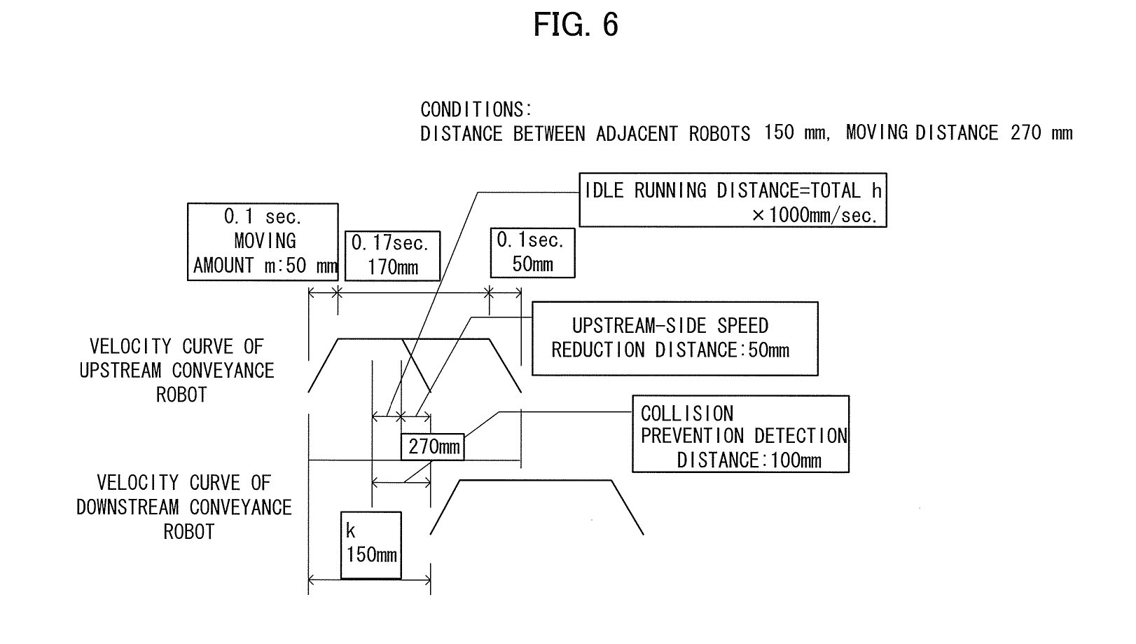

Subsequently, in step S504, the PLC 100P in the upstream process receives current position information B transmitted by the process in step S502 of the PLC 100P controlling the conveyance robot 10 frontward in the moving direction. However, at this point, there is a case where the current position information has not yet been transmitted from the PLC 100P in the downstream process through the communication line 100 and thus, the PLC 100P in the upstream process is unable to receive the current position information B. In this case, the current position information is received in step S504 of the next cycle. Subsequently, in step S505, when the current position information B is received in the process at step S504, the PLC 100P subtracts the current position information A of the conveyance robot controlled by this PLC 100P from the current position information B and obtains a positional difference B−A. The positional difference B−A is a difference between the travel distances of the respective conveyance robots 10 when these respective conveyance robots 10 are reciprocating. Normally, the conveyance robots reciprocate in the same manner and thus the positional difference is zero. However, when the conveyance robot 10 in the downstream process has been stopped in response to the operation of its temporary-stop button 100PS, the positional difference corresponds to a distance traveled by the conveyance robot in the upstream process during the time (50 msec. for two cycles) required for receiving the current position information from the PCL 100P in the downstream process at step S504. Therefore, assuming the moving speed of the conveyance robot 10 is 1000 mm/sec., the determination criterion at step S505 is set to be “50 msec.×1000 mm/sec.=50 mm”. The detailed description will be provided later when explaining FIG. 6.

Subsequently, in step S506, it is determined whether the positional difference is equal to or more than the criterion 50 mm. When it is determined that the positional difference is larger than 50 mm in step S506, the flow proceeds to “No”, and returns to step S502 and the series of processes from step S502 to step S506 are repeated. At this point, the flow returns to step S502 and the series of processes from step S502 to step S506 are repeated unless a not-ready signal is transmitted from the communication device of the PLC 100P controlling the conveyance robot 10 positioned frontward in the moving direction in step S506.

In step S506, when it is determined that the positional difference is 50 mm or less, or a not-ready signal has been transmitted from the communication device of the PLC 100P in the downstream process, the flow proceeds to “Yes” and the PLC 100P in this flow causes its own conveyance robot 10 to stop or decelerate by controlling this conveyance robot 10 in step S507.

This completes the processing for avoiding a collision, and the processing for resuming the linked motions begins afterward.

The processes from step S508 to step S511 are the same as the processes from step S502 to step S505, respectively. However, the determination process in step S512 is different from the process in step S507. After repeating the processes from step S502 to step S506, each of the PLCs then carries out the process in step S507. Subsequently, after repeating the processes from step S508 to step S512, each of the PLCs carries out the process in step S513 and then returns to step S502 to repeat the processes from step S502 to step S505 again.

In the process at step S508, in a manner similar to the processes from S502 to step S506, each of the PLCs 100P reads a current position D based on encoder signals from the encoders ENC in the conveyance robot 10 controlled by the PLC 100P in this flow and then, in the next step S509, this PLC 100P transmits the current position information to the PLC 100P controlling the conveyance robot 10 in the upstream process. In the subsequent step S510, the PLC 100P receives the current position information E transmitted from the PLC 100P controlling the conveyance robot frontward in the moving direction. In the next step S511, the PLC 100P subtracts the current position information D of the conveyance robot 10 controlled by this PLC 100P from the current position information E of the conveyance robot 10 positioned frontward in the moving direction, and obtains a positional difference E−D.

Subsequently, it is determined in step S512 whether the positional difference is larger than a set value that is 25 mm in this example. When it is determined in step S512 that the positional difference is smaller than 25 mm, the flow proceeds to “No” and returns to step S508 to repeat the processes from step S508 to step S511. When it is determined in step S512 that the positional difference is 25 mm or more, the flow proceeds to “YES” and the conveyance robot 10 stopped or decelerated is caused to start moving in step S513. Afterwards, the flow returns to step S502 to repeat the series of processes. Incidentally, in the process at step S512, the operation may be resumed assuming that the positional difference is zero, but the determination criterion is set as 25 mm assuming occurrence of a displacement corresponding to one cycle of the program.

By performing the processes in the flow of FIG. 5 in this way, the PLC 100P automatically carries out the processing for avoiding collision and the processing for recovery. Therefore, even if any of the conveyance robots 10 is stopped by the operation of its temporary-stop button 100PS, the remaining conveyance robots 10 are allowed to keep reciprocating, and the stopped conveyance robot 10 also is allowed to start reciprocating in conjunction with these remaining conveyance robots 10 after a work piece is put on the stage.

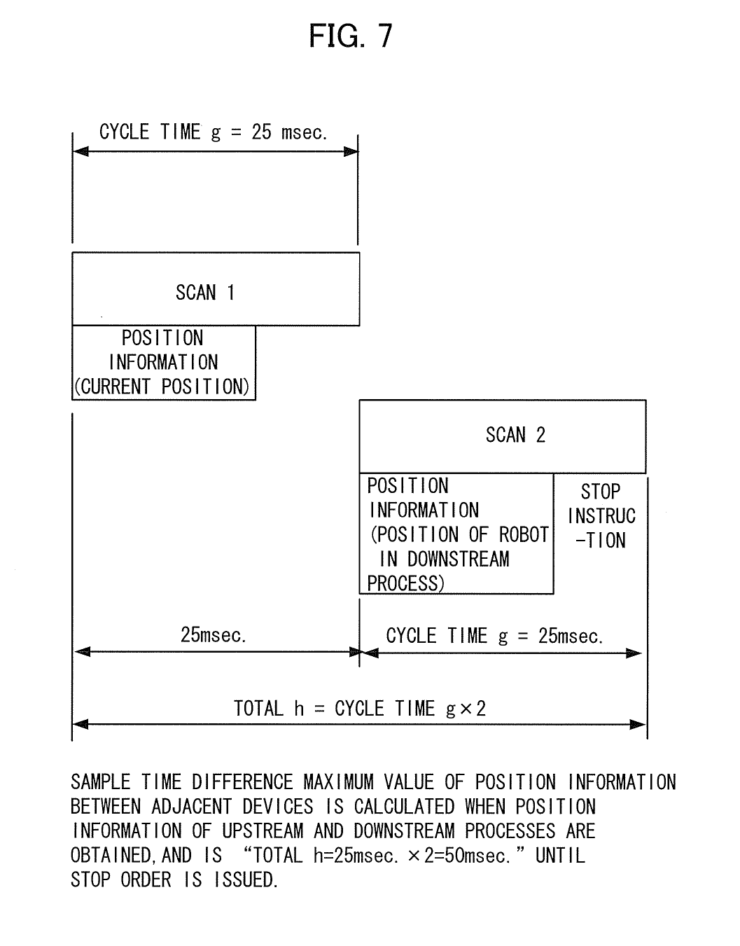

FIG. 6 and FIG. 7 are diagrams for explaining actions taking place when the program in FIG. 5 is run by the sequencer which is the PCL 100P.

In FIG. 6, a velocity curve of each of the conveyance robots 10 in the upstream and downstream processes controlled by the respective two PLCs 100P is illustrated in the form of a line graph. FIG. 7 illustrates that when the sequencer that is the PCL 100P in the upstream process runs the program in FIG. 5 thereby reciprocating the conveyance robot 10 controlled by this PCL 100P, the position information of this PCL 100P and the position information of the conveyance robot 10 positioned frontward in the moving direction are acquired with a displacement in between corresponding to one cycle. The vertical axis of the line graph illustrated in FIG. 6 indicates the speed, while the horizontal axis indicates the time.

In an upper part of FIG. 6, there is illustrated the state of a change in the speed of the mechanism of the conveyance robot in the upstream side (i.e., upstream process) and a change in the speed of the mechanism of the conveyance robot in the downstream side (i.e., downstream process).

As described above, as long as all the conveyance robots are in the active state and reciprocating together, no collision occurs. However, when the conveyance robot 10 in the downstream side is stopped near a position T in the vicinity of the origin of its reciprocating motion in response to the operation of the temporary-stop button 100PS, i.e. when the conveyance robot 10 in the downstream side is stopped at a position shifted by 150 mm from the origin of the reciprocating motion of the conveyance robot in the upstream side, the conveyance robot in the upstream side collides against the stopped conveyance robot. Therefore, the PLC 100P in the upstream process acquires the position information of the conveyance robot 10 controlled by this PLC 100P and the position information of the conveyance robot 10 positioned frontward in the moving direction (i.e., downstream process), thereby detecting the presence or absence of a collision between the conveyance robot 10 at a halt in the downstream process and the conveyance robot 10 in the upstream process. When there is a risk of occurrence of a collision, the PLC 100P causes the conveyance robot 10 in the upstream process to carry out the processing for avoiding collision.

First, with reference to FIG. 6, there will be described motions of the conveyance robot 10 in the upstream side (upstream process) assuming that the conveyance robot 10 in the downstream process is stopped at the position T in the most upstream side.

Firstly, normal motions of the conveyance robot 10 in the upstream side will be described.

Under the control of the sequencer 100P that has received an operation starting command from the controller 110 (see FIG. 4) via the network NW, the mechanism 10A of the conveyance robot 10 is first controlled to accelerate and reaches the maximum speed 1000 mm/sec. after 0.1 sec. to move 50 mm from the initial position. Subsequently, while maintaining the maximum speed 1000 mm/sec. for 0.17 sec., the mechanism 10A moves 170 mm. Afterwards, the mechanism 10A is controlled to decelerate for 0.1 sec. and then stops at a distance of 270 mm in total.

Here, for example, assume the conveyance robot 10 in the downstream process is stopped at the most frontward position in response to the operation of the temporary-stop button 100PS.

In this case, the PLC 100P in the upstream process detects a risk of occurrence of a collision in step S506 of the program that is repeating the processes in the flow of FIG. 5. When the risk is present, the PLC 100P carries out the process for stopping the conveyance robot in step S507.

As illustrated in FIG. 7, the time for one cycle (“one scan” in FIG. 7) of the program of the sequencer 100P is 25 msec. However, as illustrated in FIG. 7, there is a case in which after acquiring the current position information during the first cycle, the sequencer 100 obtains the position information at the time of running the program for the subsequent second cycle as previously described.

For this reason, when the sequencer 100P performs the process for stopping, a maximum time difference of 25 msec.×2 (for two cycles)=50 msec. occurs, causing a positional difference: 50 msec.×maximum speed 1000 mm=50 mm between the travel distance of the conveyance robot in the upstream process and the travel distance of the conveyance robot in the downstream process.

Considering this fact, to determine the presence or absence of a collision in step S506 when the program in FIG. 5 is run by the sequencer 100P, whether the conveyance robot in the downstream process is stopped or not is determined by setting 50 mm mentioned above as a criterion.

When the above-mentioned 50 mm is set as a criterion to determine whether to avoid a collision, even if the time for two cycles is required to obtain both pieces of position information, the conveyance robot of the upstream process is stopped with reliability before colliding against the conveyance robot in the downstream process. Also, when the above-mentioned 25 mm is set as a criterion to determine whether to carry out a recovery, the stopped conveyance robot is allowed to reciprocate in conjunction with the reciprocating motions of the remaining conveyance robots.

In other words, in the above-described conveyance apparatus, upon execution of the processes in the flow illustrated in FIG. 5 by each of the PLCs (sequencers) serving as a control unit, at the time when one of the conveyance robots operating in conjunction with one another is stopped, the remaining conveyance robots are allowed to keep operating in a range where no collision occurs, while avoiding occurrence of a collision. Further, when the stopped conveyance robot becomes movable while avoiding a collision, the stopped conveyance robot is allowed to resume operation in conjunction with the remaining conveyance robots.

As described above, there is realized a conveyance apparatus capable of causing, at the time when one of conveyance robots operating in conjunction with one another is stopped, the remaining conveyance robots to keep operating in a range where no collision occurs, while avoiding occurrence of a collision.

Incidentally, since the above-described embodiment is based on the assumption that dropping of a work piece that is a small problem occurs, the embodiment has been described as having such a structure that operation is automatically resumed by providing only the temporary-stop button. However, a recovery button may be provided to resume the operation.

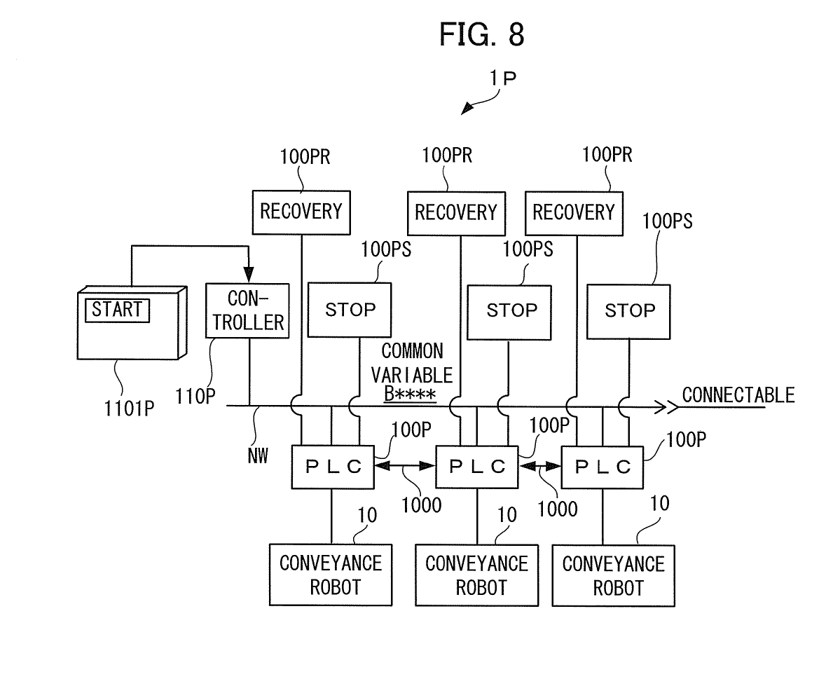

FIG. 8 is a diagram that illustrates a structure in which a recovery button 100PR is added to the structure in FIG. 4.

FIG. 8 illustrates a modified example in which the recovery button 100PR is provided to enable the conveyance robot 10, which is stopped in response to the operation of the temporary-stop button 100PS, to resume the operation in response to the operation of the recovery button 100PR.

In this structure, even when, for example, a trouble a little more complicated than the above-described dropping of a work piece occurs in any of the conveyance robots 10, the stopped conveyance robot 10 is allowed to resume the operation in conjunction with the other conveyance robots 10 by pressing the recovery button 100PR, after pressing the temporary-stop button 100PS and then resolving the trouble by taking some time. Incidentally, even in this modified structure, the flow in FIG. 5 may be employed as it is.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A conveyance apparatus comprising:
a plurality of conveyance robots each of which is provided at each of a plurality of sequential assembly processes and conveys, based on a tact system, a plurality of work pieces by simultaneously reciprocating the plurality of work pieces by using a single mechanism, the plurality of work pieces respectively existing for the plurality of sequential assembly processes and sequentially assembled on an assembly line after placed at a most upstream side of the assembly line; and
a plurality of control units respectively provided for the plurality of conveyance robots and control time sequences for reciprocating motions of the respective conveyance robots,
wherein the plurality of control units control the time sequences for the reciprocating motions of the respective conveyance robots in a linked manner, and
each of the plurality of control units controls the time sequence of a first conveyance robot among the conveyance robots and receives, from another control unit controlling the time sequence of a second conveyance robot among the conveyance robots, position information of the second conveyance robot positioned frontward in a moving direction of the first conveyance robot, thereby detecting presence of a risk of a collision with the second conveyance robot, and causing the first conveyance robot to act to avoid the collision when the risk of the collision is present.

2. The conveyance apparatus according to claim 1, wherein the plurality of control units are mutually connected by a network and control the time sequences for the reciprocating motions of the respective conveyance robots through communications via the network, and
each of the plurality of control units is connected by respective communication lines to two of the control units respectively controlling two of the conveyance robots on both sides of the control unit, and transmits position information of the conveyance robot under control of the control unit to the two of the control units, and further, each of the plurality of control units controls the time sequence of a first conveyance robot among the plurality of conveyance robots and receives, via the communication line, from the control unit controlling a second conveyance robot among the conveyance robots, position information of the second conveyance robot positioned frontward in a moving direction of the first conveyance robot.

3. The conveyance apparatus according to claim 2, wherein each of the plurality of control units comprises a parallel communication device that transmits and receives parallel data representing the position information via the communication lines.

4. The conveyance apparatus according to claim 2, wherein each of the plurality of control units comprises a serial communication device that transmits and receives serial data representing the position information via the communication lines.

5. The conveyance apparatus according to claim 1, wherein each of the plurality of control units is a sequencer that runs a program comprising:
monitoring repeatedly presence of a risk of a collision between the first conveyance robot under control of the control unit and the second conveyance robot positioned frontward in the moving direction of the first conveyance robot;
controlling the first conveyance robot thereby stopping the first conveyance robot when the risk of the collision occurs;
monitoring repeatedly possibility of movement that avoids the collision with the second conveyance robot; and
resuming movement of the first conveyance robot when the movement that avoids the collision with the second conveyance robot is possible.

6. The conveyance apparatus according to claim 1, wherein each of the plurality of control units comprises a temporary-stop button for stopping the conveyance robot under control of the control unit and a recovery button for resuming movement of the conveyance robot.
